(19) United States
(12) Patent Application Publication
(10) Pub. No.: US 2026/0307311 A1
(43) Pub. Date: Oct. 8, 2026

(54) MULTI-APPEARANCE OVERMOLDED VEHICLE COMPONENT

(71) Applicant: Magna Exteriors Inc., Aurora (CA)

(72) Inventors: Stanislav Tichy, Troy, MI (US); Riad Chaaya, Clarkston, MI (US); Peter Harris, Rochester Hills, MI (US); Michael Pailey, Essex (CA); John S. Muglia, Shelby Township, MI (US); Heiner Salzmann, Metamora, MI (US); Pavel Petera, Liberec (CZ); Miguel Benitez, Mainhausen (DE); Axel Lachenmaier, Rudersberg (DE); Kevin O'Callaghan, Troy, MI (US); Mark J. Hess, Gaines, MI (US)

(21) Appl. No.: 19/566,221

(22) Filed: Mar. 13, 2026

Related U.S. Application Data
(60) Provisional application No. 63/783,732, filed on Apr. 4, 2025.

(51) Int. Cl. B29C 45/16; B29C 45/14; B29K 75/00; B29L 31/30

(52) U.S. Cl. CPC B29C 45/1671; B29C 45/1675; B29C 45/14336; B29K 2075/00; B29L 2031/30

(57) ABSTRACT

A method for forming an overmolded component may include providing a substrate within a mold assembly having multiple mold parts, providing a first overmold cavity that is defined at least in part by the substrate and one or more of the mold parts, providing a second overmold cavity that is defined at least in part by the substrate and one or more of the mold parts, and providing a material in the first overmold cavity to form a first overmolded layer on the substrate and into the second overmold cavity to form a second overmolded layer on the substrate, wherein the first overmolded layer is formed separately from the second overmolded layer.

### REFERENCE TO RELATED APPLICATION

This application claims the benefit of U.S. Provisional Patent Application Ser. No. 63/783,732 filed on Apr. 4, 2025 the content of which is incorporated herein by reference in its entirety.

### FIELD

The present disclosure relates to an apparatus and method incorporating in-mold polyurethane (PUR) with one or more vehicle components.

### BACKGROUND

Vehicle components such as front fascias, body panels, or other parts may include assemblies of two or more pieces to achieve multi-color or multi-textured appearances. However, assemblies of two or more pieces increase the production cost and assembly time of each component, and may also introduce additional manufacturing complexity, alignment challenges, and potential durability issues at interfaces between the pieces.

### SUMMARY

In at least some implementations, a method for forming an overmolded component includes providing a substrate within a mold assembly having multiple mold parts, providing a first overmold cavity that is defined at least in part by the substrate and one or more of the mold parts, providing a second overmold cavity that is defined at least in part by the substrate and one or more of the mold parts, and providing a material in the first overmold cavity to form a first overmolded layer on the substrate and into the second overmold cavity to form a second overmolded layer on the substrate, wherein the first overmolded layer is formed separately from the second overmolded layer.

In at least some implementations, one of the mold parts engages the substrate between the first overmold cavity and the second overmold cavity to prevent material in the first overmold cavity from flowing into the second overmold cavity and vice versa.

In at least some implementations, said one of the mold parts defines part of one or both of the first overmold cavity and the second overmold cavity.

In at least some implementations, the material provided in the first overmold cavity is a polyurethane with a first appearance or first material composition and the material provided in the second overmold cavity is a polyurethane with a second appearance that is different than the first appearance or a second material composition that is different than the first material composition.

In at least some implementations, the first appearance is a first color, a first texture, a first gloss or reflectivity, a first pattern, a first transparency, or a first surface finish and the second appearance is a second color, a second texture, a second gloss or reflectivity, a second transparency, or a second finish.

In at least some implementations, the substrate is molded in the mold system and remains in the mold system while the first overmolded layer and the second overmolded layer are formed on the substrate.

In at least some implementations, the substrate has an outer surface that defines part of the first overmold cavity and part of the second overmold cavity, the substrate includes a separation feature in the outer surface and both of the first overmold cavity and the second overmold cavity are defined in part by part of the separation feature.

In at least some implementations, the separation feature is a groove that extends inwardly into the outer surface of the substrate, and a step is formed within the groove, and the step defines at least part of the first overmold cavity or the second overmold cavity.

In at least some implementations, said one of the mold parts engages the substrate within a groove of the substrate.

In at least some implementations, the substrate has a first ridge and said one of the mold parts has a protrusion in contact with the ridge to define at least part of one or both of the first overmold cavity and the second overmold cavity.

In at least some implementations, the ridge defines part of one or both of the first overmold cavity and the second overmold cavity.

In at least some implementations a method for forming an overmolded component, includes forming a substrate within a mold assembly having multiple mold parts. A first overmold cavity is provided that is defined at least in part by the substrate and one or more of the mold parts. The method also includes providing a second overmold cavity that is defined at least in part by the substrate and one or more of the mold parts, wherein the second overmold cavity is spaced from the first overmold cavity, providing a first overmold material in the first overmold cavity to form a first overmolded layer on the substrate, and providing a second overmold material into the second overmold cavity to form a second overmolded layer on the substrate, wherein the first overmolded layer is different from the second overmolded layer in appearance, composition or both appearance and composition.

In at least some implementations, the substrate is formed in a substrate cavity defined between a first mold part and a second mold part, and part of one or both the first overmold cavity and the second overmold cavity is defined by a third mold part that engages the substrate at an edge of the one or both of the first overmold cavity and the second overmold cavity.

In at least some implementations, the first overmold cavity is formed in part by the third mold part and the second overmold cavity is formed in part by a fourth mold part, the third mold part engages the substrate at an edge of the first overmold cavity and the fourth mold part engages the substrate or the first overmolded layer at an edge of the second overmold cavity.

In at least some implementations, the first overmolded layer is formed on the substrate first, the third mold part is withdrawn from the substrate, and then the fourth mold part is advanced onto the substrate and the second overmolded layer is formed on the substrate.

In at least some implementations, the fourth mold part engages the first overmolded layer and the second overmold cavity is defined in part by the first overmolded layer.

In at least some implementations, the first overmolded layer is different from the second overmolded layer in color, texture, gloss or reflectivity, pattern, transparency, or surface finish.

In at least some implementations, a vehicle component includes a substrate with a separation feature that extends outwardly from or inwardly into an outer surface of the substrate with a first overmolded layer formed on the outer surface of the substrate that contacts part of the separation feature and has a first appearance, and a second overmolded layer formed on the outer surface of the substrate that contacts part of the separation feature and has a second appearance that is different from the first appearance.

In at least some implementations, the first overmolded layer is formed of polyurethane with a first appearance and the second overmolded layer is formed of polyurethane with a second appearance that is different than the first appearance.

In at least some implementations, the first appearance is a first color, a first texture, a first gloss or reflectivity, a first transparency, or a first finish and the second appearance is a second color, a second texture, a second gloss or reflectivity, a second transparency, or a second finish.

In at least some implementations, the first overmolded layer and second overmolded layer are separated by a gap and are not in contact with each other.

In at least some implementations, the first overmolded layer and the second overmolded layer are in contact with each other within a groove of the substrate that defines the separation feature, or on opposite sides of a ridge of the substrate that defines the separation feature.

### BRIEF DESCRIPTION OF THE DRAWINGS

FIG. 1 is a diagrammatic front view of a multi-appearance vehicle component;

FIGS. 2a-2f are cross-sectional views of multi-appearance vehicle components;

FIGS. 3a-3b are additional cross-sectional views of multi-appearance vehicle components;

FIG. 4a is a cross-sectional view of a substrate formed in a substrate mold cavity;

FIG. 4b is a cross-sectional view of two overmolded layers formed on the substrate within first and second overmold cavities;

FIG. 5a is a cross-sectional view of a substrate formed in a substrate mold cavity;

FIG. 5b is a cross-sectional view of two overmolded layers formed on the substrate within first and second overmold cavities;

FIG. 5c is a cross-sectional view of two overmolded layers formed on the substrate within first and second overmold cavities;

FIG. 6a is a cross-sectional view of a substrate formed in a substrate mold cavity;

FIG. 6b is a cross-sectional view of two overmolded layers formed on the substrate within first and second overmold cavities;

FIG. 7a is a cross-sectional view of a substrate formed in a substrate mold cavity;

FIG. 7b is a cross-sectional view of two overmolded layers formed on the substrate within first and second overmold cavities;

FIG. 8a is a cross-sectional view of a substrate formed in a substrate mold cavity;

FIG. 8b is a cross-sectional view of two overmolded layers formed on the substrate within first and second overmold cavities;

FIG. 9a is a cross-sectional view of a substrate formed in a substrate mold cavity;

FIG. 9b is a cross-sectional view of two overmolded layers formed on the substrate within first and second overmold cavities;

FIG. 10a is a cross-sectional view of a substrate formed in a substrate mold cavity;

FIG. 10b is a cross-sectional view of two overmolded layers formed on the substrate within first and second overmold cavities;

FIG. 11a is a cross-sectional view of a first overmolded layer formed on a substrate within a first overmold cavity;

FIG. 11b is a cross-sectional view of a second overmold cavity formed adjacent to the first overmolded layer;

FIG. 11c is a cross-sectional view of a second overmolded layer formed within the second overmold cavity;

FIG. 12a is a cross-sectional view of a first overmolded layer formed on a substrate within a first overmold cavity;

FIG. 12b is a cross-sectional view of a second overmold cavity formed adjacent to the first overmolded layer;

FIG. 12c is a cross-sectional view of a second overmolded layer formed within the second overmold cavity;

FIG. 13a is a perspective cross-sectional view of a substrate with a rib and two overmolded layers formed on the substrate;

FIG. 13b is a perspective cross-sectional view of a substrate with a rib and two overmolded layers formed on the substrate; and

FIG. 14 depicts a method for forming a multi-appearance overmolded vehicle component.

### DETAILED DESCRIPTION

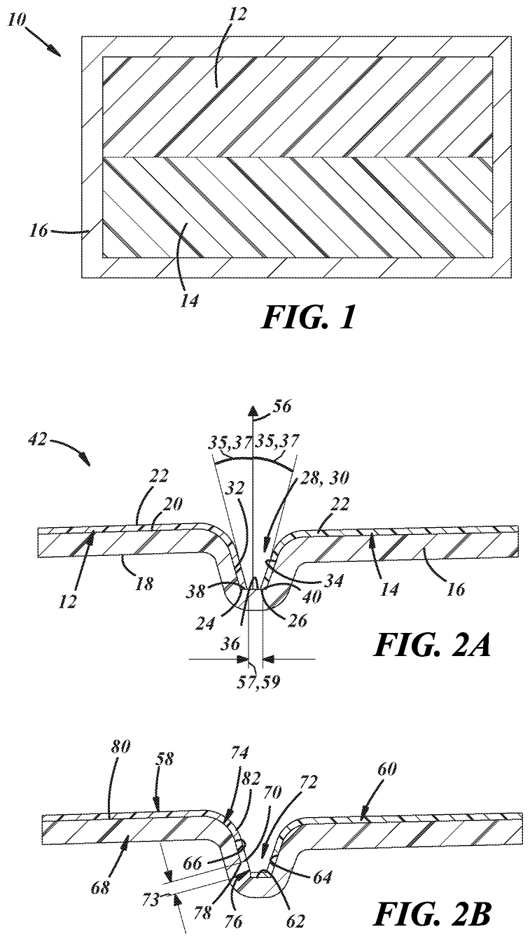

Referring in more detail to the drawings, FIG. 1 shows a front view of a multi-appearance overmolded vehicle component 10, which may be used for example, as a front fascia, rear fascia, other vehicle body panel, or other vehicle component. In at least some implementations, vehicle component 10 includes a first overmolded layer 12 that may have a first appearance (e.g., a first color, surface finish, texture, pattern, gloss or reflectivity, etc.), and a second overmolded layer 14 that may have a second appearance (e.g., a second color, finish, texture, etc.) that is different than the first appearance. The first and second overmolded layers 12, 14 may be overmolded or formed on a substrate 16, which is the base or underlying part onto which the first and second overmolded layers 12, 14 are molded. In at least some implementations, the first and second overmolded layers 12, 14 are PUR (polyurethane reactive) material. In PUR molding, liquid reactive components are injected into a mold, where they flow easily to fill complex geometries and then chemically react to form a solid, crosslinked polymer. This process allows PUR materials to achieve high strength, durability, and resistance to heat, chemicals, and abrasion.

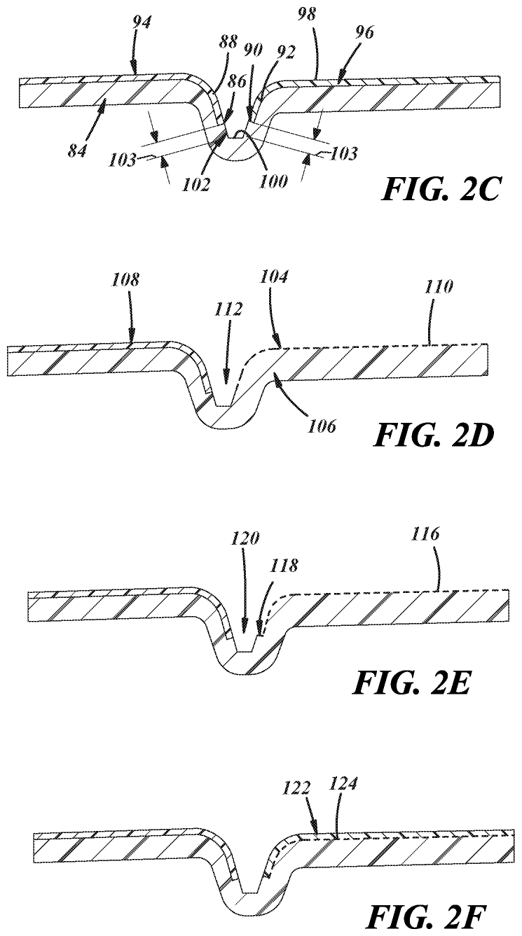

The substrate provides structural support and defines the shape of the vehicle component 10, while the overmolded layers 12, 14 bond to the substrate 16 to add functional or aesthetic properties to the vehicle component 10. As shown in FIG. 2a, the substrate 16 has a thickness defined between an inner surface 18 and an opposite, outer surface 20. In at least some implementations, the first and second overmolded layers 12, 14 are formed on the outer surface 20 of the substrate 16 to form part of all of an exterior surface 22 of the vehicle component 10. The first and second overmolded layers 12, 14 may be arranged next to each other, with edges 24, 26 parallel to each other along a seam, and optionally touching along the seam or separated by a gap.

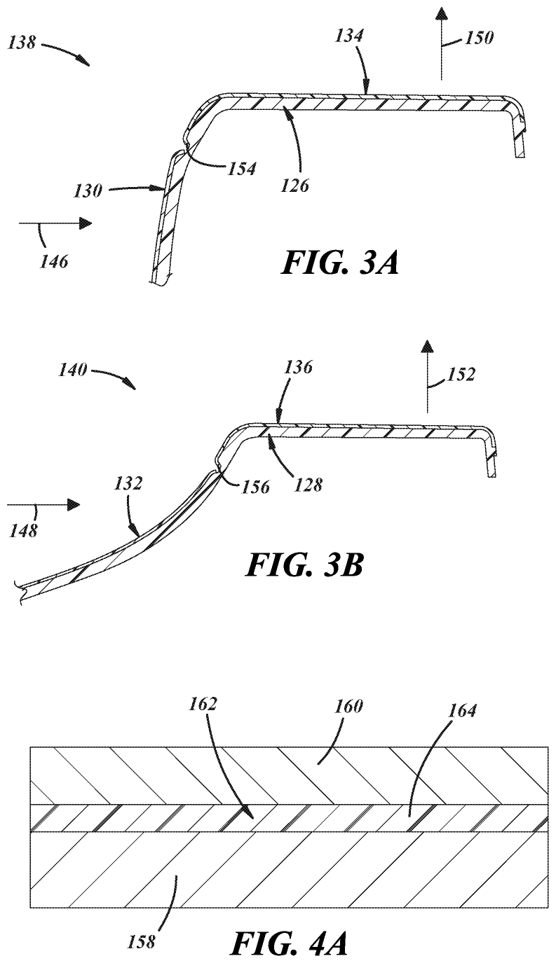

In at least some implementations, the substrate 16 includes a separation feature 28 extending between the adjacent edges 24, 26 of the overmolded layers 12, 14, and which may define at least part of the gap between the overmolded layers 12, 14. In the examples shown in FIGS. 2a-3b, the separation feature 28 is a concavity, such as a channel or groove 30 that extends inwardly and is recessed relative to at least a portion of the outer surface 20 of the substrate 16. The groove 30 may extend the full length of the adjacent edges 24, 26 of the overmolded layers 12, 14, and may be defined by two opposing side surfaces, a first side surface 32 and a second side surface 34, that are spaced apart from one another and a base 36 positioned between the side surfaces 32, 34. The side surfaces 32, 34 may be oppositely oriented at angles relative to a direction of removal 36 of a mold part used to form the substrate 16 and/or one or both of the overmolded layers 12, 14, during the manufacturing process of the vehicle component 10. For example, the possible direction of removal 56 of a mold part is shown by an arrow in FIG. 2a. In at least some implementations, the side surfaces 32, 34 extend at an angle 35 between 1 and 10 degrees from the direction of removal of a mold part. In at least some implementations, the side surfaces 32, 34 extend at an angle 37 greater than 7 degrees from the direction of removal of the mold part. These angles 35, 37 from the direction of removal of a mold part may permit the mold part to be moved away from the formed part after the first and second overmolded layers 12, 14 are formed without damage to the first and second overmolded layers 12, 14.

Each side surface 32, 34 forms a boundary of the groove 30 and forms a transition from the outer surface 20 of the substrate 16 outboard of the groove 30 to the base 36. The base 36 connects at or defines lower ends 38, 40 of the side surfaces 32, 34 and defines a maximum depth of the groove 30, thereby creating a recessed channel in the substrate 16 that may be configured to receive at least part of the first overmolded layer 12 and/or the second overmolded layer 14. The groove 30 may be configured to hide or obscure edges or seams of the first overmolded layer 12 and the second overmolded layer 14. This may reduce manufacturing costs by not requiting a perfect seam between the first overmolded layer 12, the second overmolded layer 14, and in at least some implementations, the substrate 16.

To hide the transition between the overmolded layers 12, 14 and/or to maintain the materials of the overmolded layers 12, 14 separated along the adjacent edges 24, 26 of the overmolded layers 12, 14, multiple configurations of the first overmolded layer 12 and second overmolded layer 14 relative to the separation feature 28 are possible. Referring specifically to FIG. 2a, the vehicle component 42 has the first overmolded layer 12 and the second overmolded layer 14 are formed into the groove 30, each over a respective one of the side surfaces 32, 34, so that the first overmolded layer 12 and the second overmolded layer 14 are formed against at least part of the base 36. In at least some implementations, the base 36 may be 5 mm or less perpendicular to the direction of removal 56 of the mold part (distance 57) and/or the first overmolded layer 12 and second overmolded layer 14 may be separated by 5 mm or less at the base 36 (distance 59).

In at least some implementations, the first overmolded layer 58 and/or the second overmolded layer 60 may be formed at least partially along the base 62. For example, as shown in FIG. 2b, the second overmolded layer 60 is formed on both the second sidewall 64 and the base 62. In at least some implementations, one of the first overmolded layer 58 or the second overmolded layer 60 contacts at least part of both sidewalls 64, 66. As shown in FIG. 2b, the second overmolded layer 60 is formed on the second sidewall 64 and the base 62 of the substrate 68 and contacts a portion of the first sidewall 66.

In at least some implementations, the substrate 66 includes one or more steps 70 within the groove 72. For example, as shown in FIG. 2b, a step 70 is present in the first sidewall 66 within the groove 72. The step 70 may be an offset formed between an upper portion 74 and a lower portion 76 of the sidewall 66 that extends into the groove 72 farther than the upper portion 74. In at least some implementations, the step 70 is positioned to define an edge 78 or boundary of the overmolded layer 58 in the groove 72 such that the overmolded layer 58 terminates at the step 70 and is flush with the surrounding outer surface 80 of the substrate 68 in the lower portion 76 of the sidewall 66. In this way, the step 70 defines a transition boundary that allows the overmolded layer 58 and the substrate 68 to form a continuous, smooth outer surface without a visible ridge. As shown in FIG. 2b, the step 70 is formed in the first sidewall 58 between the upper and lower portions 74, 76 and may extend a full length of the edge of the first overmolded layer 58 that is in the groove 30. The first overmolded layer 58 terminates at the step 70 and forms a continuous outer surface 82 with the substrate 68. In at least some implementations, the step 70 may be 0.2 to 4 mm from the base 62 of the groove 72 (distance 73).

As shown in FIG. 2c, the substrate 84 may have more than one step. For example, the substrate 84 may have a first step 86 on the first sidewall 88 and a second step 90 on the second sidewall 92. The first overmolded layer 94 may terminate at the first step 86 of the first sidewall 88 and the second overmolded layer 96 may terminate at the second step 90 of the second sidewall 92 to form a continuous outer surface 98 between the first overmolded layer 94, the second overmolded layer 96, and at least part of the substrate 84. In at least some implementations, the first step 86 and the second step 90 are both 0.2 to 4 mm from the base 100 of the groove 102 (distance 103).

In at least some implementations, as shown by FIGS. 2d-2f, at least part of the substrate or one or more of the overmolded layers may have a different material composition and/or visual appearance. As shown by FIG. 2d, a portion 104 of the substrate 106 adjacent to the first overmolded layer 108 has a texture 110. The texture 110 may include, for example, a roughened surface, a patterned surface, graining, dimples, metallic flake or others and may be intended to enhance adhesion between the substrate 106 and the overmolded material, or for aesthetic purposes. The texture 110 may extend at least partially into the groove 112, and in at least some implementations the texture 116 may extend up to a step 118 in the groove 120 as shown in FIG. 2e. As shown in FIG. 2f, an overmolded layer 122 may be formed over the texture 124 to provide a desired appearance. In at least some implementations, the overmolded layer 122 formed over the texture 124 may have one or more attributes that contribute to the appearance of the component. For example, the overmolded layer 122 over the texture 124 may differ in color, tint, or may contain a metallic flake, to name a few possibilities.

As shown in FIGS. 3a-3b, the substrate 126, 128, first overmolded layer 130, 132, and/or the second overmolded layer 134, 136 may be shaped differently than as shown in the preceding figures. In at least some implementations, the shape of the component 138, 140 may require the use of multiple molds or sliders engaged from multiple directions to form the substrate 126, 128 and the first and second overmolded layers 130, 132, 134, 136. As shown in FIGS. 3a-3b, a first mold part may be moved in a first mold direction 146, 148 to establish a first cavity in which the first overmolded layer 130, 132 is formed. The first mold part may also establish at least part of a second cavity in conjunction with a second mold part engaged or moved in a second mold direction 150, 152, which may be a slider or other mold depending on the implementation and geometry of the substrate 126, 128. The first mold part and second mold part may meet at an edge which defines a gap between the first cavity and the second cavity. In at least some implementations, the edge or gap may include an additional seal material to seal the boundary between the first and second molds and to prevent leakage between the molds. In at least some implementations, a substrate lifter may be used to form the substrate. The substrate lifter may be a tooling or mold feature used to position the substrate relative to the one or more molds during the overmolding process. Further, a third mold part may be moved in a third direction relative to the substrate and may form an undercut or protrusion in the substrate, a side of which defines a step that defines an edge 154, 156 of the second overmolded layer 134, 136, as shown in FIGS. 3a and 3b.

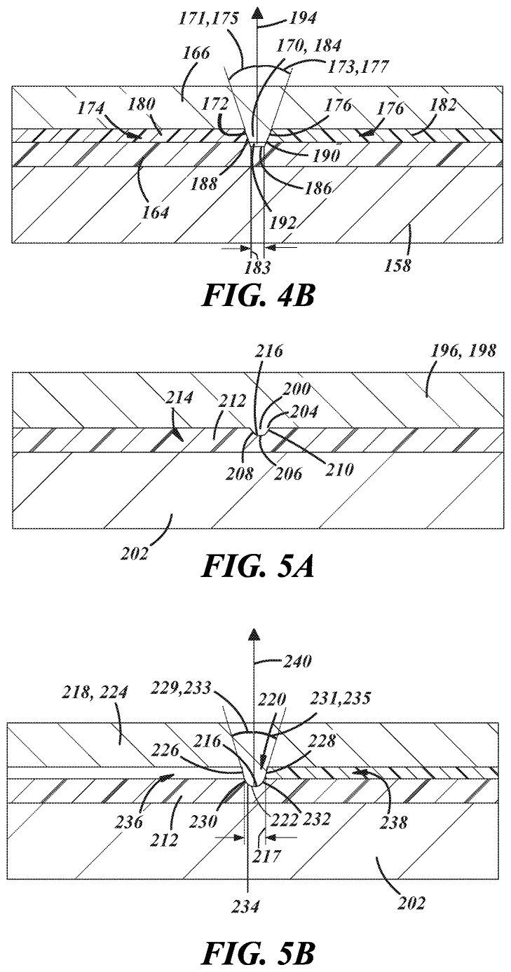

Referring now generally to FIGS. 4a-10b, various implementations of mold parts for forming the substrate are shown. Referring to FIG. 4a, the mold parts include a first mold part 158 and a second mold part 160 that together define a substrate cavity 162 in which material to form the substrate 164 is provided. After the substrate material fully or partially cures, the second mold part 160 may be replaced with a third mold part 166, as shown in FIG. 4b. The third mold part 166 may contact the substrate 164 in at least one place and defines at least part of one overmold cavity. In the example shown, the third mold part 166 includes a protrusion 170 or flange that contacts the substrate 164 and defines on a first side 172 of the protrusion 170 part of a first overmold cavity 174 and defines on a second side 176 of the protrusion 170 part of a second overmold cavity 178. The first overmolded layer 180 is formed in the first overmold cavity 174 and the second overmolded layer 182 is formed in the second overmold cavity 178.

The substrate, third mold part, or both the substrate and third mold part may have a separation feature to form first and second mold cavities. As shown in FIG. 4b, the separation feature 184 may be a protrusion 186 on the third mold part 166 that seals against the substrate 164 and inhibits or prevents material from leaking out of the first overmold cavity 174 or second overmold cavity 178, and the protrusion 170 may thereby define the gap between the overmolded layers 180, 182 in the finished product. In at least some implementations, the protrusion 170 has a free end or peak 186 that is between 0.5 to 5 mm in width between the first side 172 and the second side 174, and the protrusion 170 extends the full length of the adjacent edges 188, 190 of the first and second overmolded layers 180, 182 (distance 183). In at least some implementations, as shown in FIG. 4b, the peak 186 may be flat or planar. The protrusion 170 contacts and may deform the substrate 164, to provide a seal 192 between the substrate and the protrusion 170. In at least some implementations, the sides 172, 176 of the protrusion 170 extend at angles 171, 173 from 1 to 10 degrees relative to a direction of removal 194 of the third mold part 166. In at least some implementations, the sides 172, 176 of the protrusion 170 extend at angles 175, 177 greater than 7 degrees relative to the direction of removal 194 of the third mold part 166.

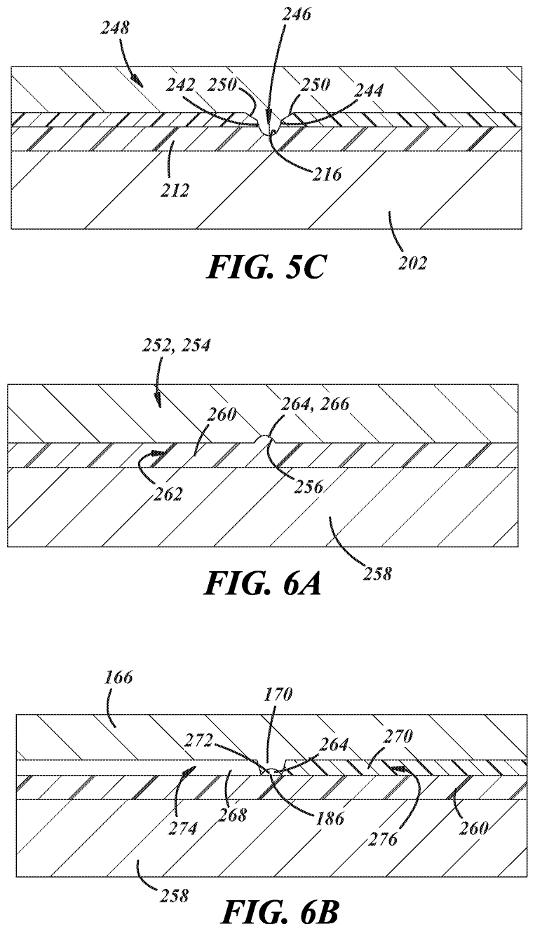

Referring now to FIG. 5a, the second mold part 196 has a body 198 and a protrusion 200 extending towards the first mold part 202 from the body 198. The protrusion 200 has a base 204 and a peak 206 with sides 208, 210 extending between the base 204 and the peak 206. So arranged, when the substrate 212 is formed within the substrate cavity 214, the protrusion 200 forms a groove 216 within the substrate 212.

Referring now to FIG. 5b, the third mold part 218 has a protrusion 220 with a rounded peak 222 spaced from the body 224. In at least some implementations, the peak 222 is between 0.5 to 5 mm in width between the first side 226 and the second side 228 at the outer edges 230, 232 of the groove 216 (distance 217). The protrusion 220 is configured to contact the groove 216 of the substrate 212 and form a seal 234 between the substrate 212 and the protrusion 220. The first overmold cavity 236 is defined at least in part by the third mold part 218, the substrate 212, and the first side 226 of the protrusion 220. The second overmold cavity 238 is defined at least in part by the third mold part 218, the substrate 212, and the second side 228 of the protrusion 220. In at least some implementations, the sides 226, 228 of the protrusion 220 extend at angles from 1 to 10 degrees relative to a direction of removal 240 of the third mold part 218. In at least some implementations, the sides 226, 228 of the protrusion 220 extend at angles 233, 235 greater than 7 degrees relative to the direction of removal 240 of the third mold part 218. In at least some implementations, such as shown in FIG. 5c, the sides 242, 244 of the protrusion 246 of the third mold part 248 may not have a continuous angle, possibly due to a chamfer or round 250 formed in the protrusion 246.

Referring now to FIG. 6a, the second mold part 252 has a body 254 and a recess 256 extending away from the first mold part 258. When the substrate 260 is formed within the substrate cavity 262, the recess 256 forms an outwardly extending ridge 264 on the substrate. The ridge 264 defines a separation feature 266 which can define a gap between the overmolded layers 268, 270.

Referring now to FIG. 6b, the third mold part 166 may be as described previously with regard to FIG. 4b. The peak 186 of the third mold part's protrusion 170 may at least partially deform the ridge 264 of the substrate 260 to provide a seal 272 between the third mold part 166 and the substrate 260. The first overmold cavity 274 is defined at least in part by the third mold part 166, the substrate 260, and the first side 172 of the third mold part's protrusion 170. The second overmold cavity 276 is defined at least in part by the third mold part 166, the substrate 260, and the second side 176 of the third mold part's protrusion 170. In this way, the seal 272 between the third mold part 166 and the substrate 260 prevents leakage between the first overmold cavity 274 and the second overmold cavity 276.

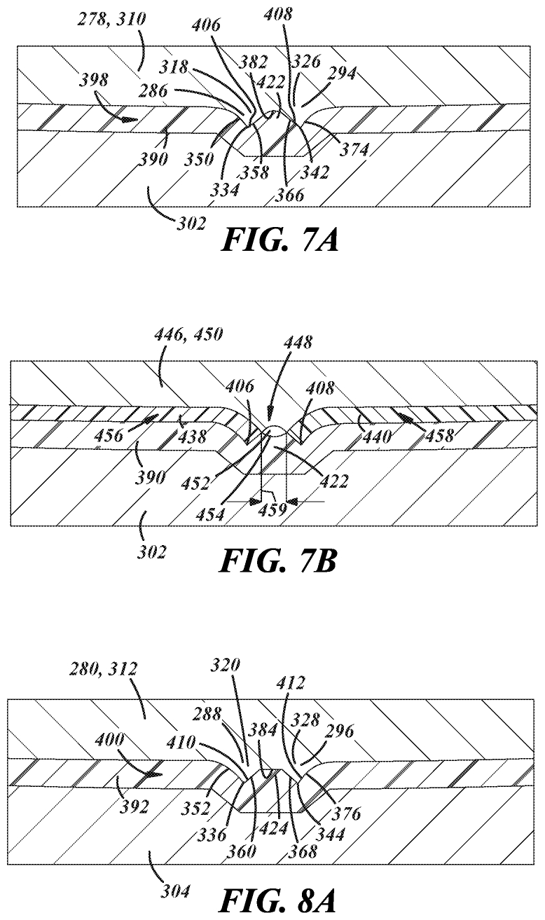

Referring now to FIGS. 7a, 8a, 9a, and 10a the second mold part 278-284 has two protrusions 286-300 extending towards the first mold part 302-308 from the body 310-316. Each protrusion 286-300 has a base 318-332 and a peak 334-348 with sides 350-380 extending between the base 318-332 and the peak 334-348. A recess 382-389 is defined between the protrusions 286-300, so that, when the substrate 390-396 is formed within the substrate cavity 398-404, the protrusions 286-300 forms two spaced apart grooves 406-420 that extend at least partially into the substrate 390-396 and a ridge 422-428 between the two grooves 406-420 on the substrate 390-396. The protrusions 286-300 may be parallel to each other and may extend the length of an edge of one or both of the overmolded layers 430-444.

Referring now to FIG. 7b, the third mold part 446 may have a protrusion 448 that extends from the third mold part's body 450 and has a rounded peak 452. The rounded peak 452 may contact and at least partially deform the ridge 422 of the substrate 390, forming the seal 454 between the substrate 390 and the third mold part 450. In at least some implementations the seal 454 is between 0.5 to 5 mm as measured between the overmold cavities 456, 458 (distance 459). The first overmold cavity 456 is defined at least in part by the third mold part 450, the substrate 390, and a first groove 406 adjacent to the ridge 422 of the substrate 390. The second overmold cavity 458 is defined at least in part by the third mold part 450, the substrate 390, and a second groove 408 adjacent to the ridge 422 of the substrate 390. In this way, the seal 454 between the third mold part 450 and the substrate 390 prevents leakage between the first overmold cavity 456 and the second overmold cavity 458.

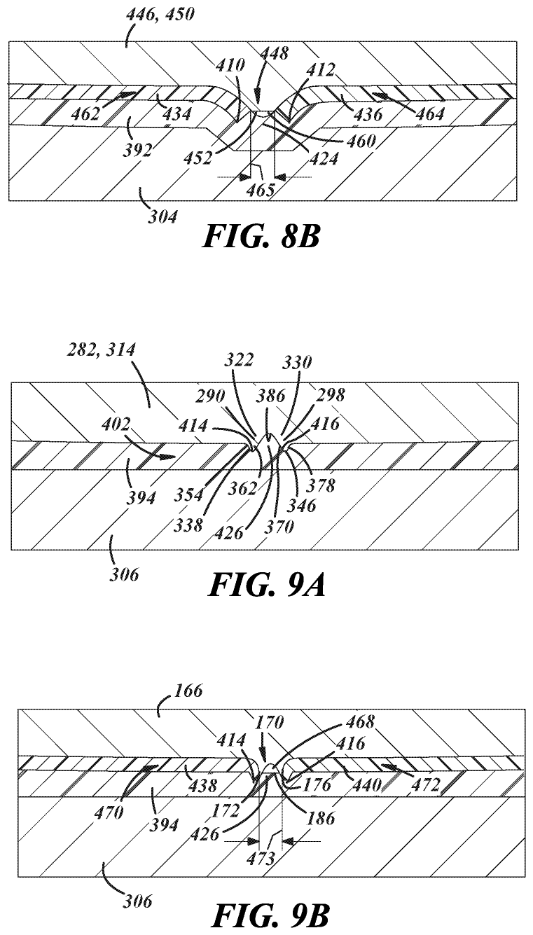

Referring specifically to FIG. 8a, the recess 384 between the protrusions 288, 296 of the second mold part 280 includes at least a portion that is planar or flat, so that the ridge 424 of the substrate 392 between the two grooves 410, 412 has at least a portion that is planar or flat. The protrusion 448 of the third mold part 450 in FIG. 8b may be as previously described with regard to the third mold part of FIG. 7b. The rounded peak 452 of the third mold part 450 may contact and at least partially deform the ridge 424 of the substrate 392, forming the seal 460 between the substrate 390 and the third mold part 450. In at least some implementations the seal 460 is between 0.5 to 5 mm as measured between the cavities 462, 464 (distance 465). The first overmold cavity 462 is defined at least in part by the third mold part 450, the substrate 392, and a first groove 410 adjacent to the ridge 424 of the substrate 392. The second overmold cavity 464 is defined at least in part by the third mold part 450, the substrate 392, and a second groove 412 adjacent to the ridge 424 of the substrate 392. In this way, the seal 460 between the third mold part 350 and the substrate 392 prevents leakage between the first overmold cavity 462 and the second overmold cavity 464.

Referring now to FIG. 9a, the second mold part 282 has a body 314 and a first protrusion 290 and second protrusion 298 spaced from the first protrusion 290. Each protrusion 290, 298 extends towards the first mold part 306 from the body 314 and to respective first and second peaks 338, 346. A recess 386 is positioned between the peaks 338, 346 and extends into the second mold part 282. When the substrate 394 is formed within the substrate cavity 402, the first protrusion 290 of the second mold part 282 forms a first groove 414 in the substrate 394, the recess 386 of the second mold part 282 forms a ridge 426 on the substrate 394, and the second protrusion 298 of the second mold part 282 forms a second groove 416 in the substrate 394.

Referring now to FIG. 9b, the third mold part 166 may be as previously described with regard to FIG. 4b with a protrusion 170 with a flat peak 186. The flat peak 186 of the third mold part 166 may contact and at least partially deform the ridge 426 of the substrate 394, forming a seal 468 between the substrate 394 and the third mold part 166. In at least some implementations the length of the seal 394 is between 0.5 to 5 mm as measured between the cavities 470, 472 (distance 473). The first overmold cavity 470 is defined at least in part by the third mold part 166, the substrate 394, the first groove 414 of the substrate 394, and the first side 172 of the protrusion 170 of the third mold part 166. The second overmold cavity 470 is defined at least in part by the third mold part 166, the substrate 394, the second groove 416 of the substrate 394, and the second side 176 of the protrusion 170 of the third mold part 166. In this way, the seal 468 between the third mold part 166 and the substrate 394 prevent leakage between the first overmold cavity 470 and the second overmold cavity 472.

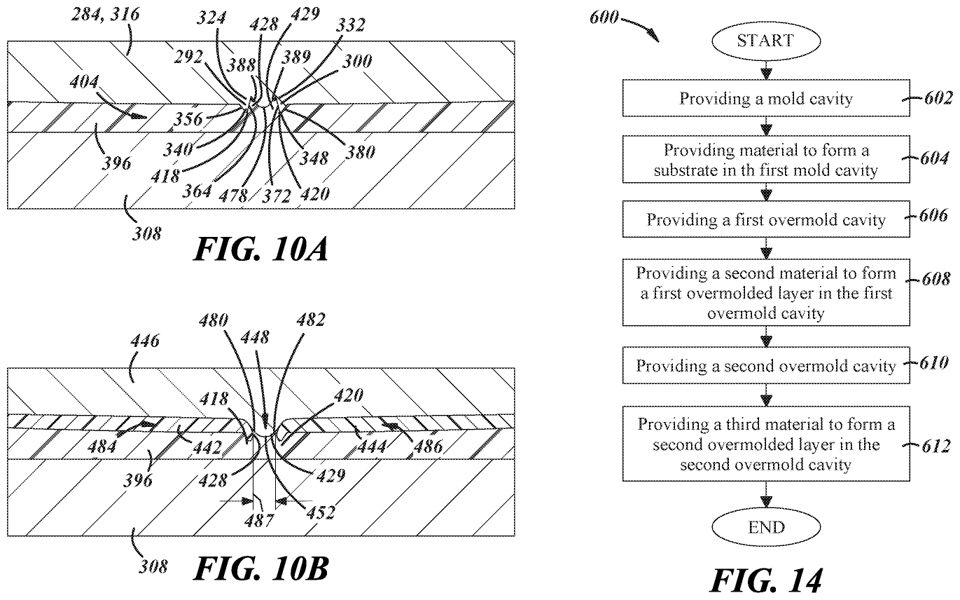

Referring now to FIG. 10a, the second mold part 284 has a body 316 and a first protrusion 292 and a second protrusion 300 that extend towards the first mold part 308 from the body 316 and to respective first and second peaks 340, 348. The second mold part 284 also has a first recess 388 that is positioned adjacent to the first protrusion 292 and extends into the second mold part 284 and a second recess 389 that extends into the body 316, is spaced from the first recess 388 and is positioned adjacent to the second protrusion 300 and the first recess 388. A third protrusion 478 may be defined between the recesses 388, 389, if desired. Each protrusion 292, 300 has a base 324, 332 and a peak 340, 348 with sides 356, 364 extending between the base 324 and peak 340. When the substrate 396 is formed within the substrate cavity 404, the protrusions 292, 300 of the second mold part 284 form grooves 418, 420 in the substrate 396, and the recesses 388, 389 in the second mold part 284 form ridges 428, 429 extending outwardly in the substrate 396.

Referring now to FIG. 10b, the third mold part 446 may be as previously described with regard to FIG. 7b with a protrusion 446 with a rounded peak 452. The rounded peak 452 of the third mold part 446 may contact and at least partially deform the first and second ridges 428, 429 of the substrate 396, forming two seals 480, 482 between the substrate 396 and the third mold part 446. In at least some implementations the distance between the seals 480, 482 is between 0.5 to 5 mm as measured between the first and second overmold cavities 484, 486 (distance 487). The first overmold cavity 484 is defined at least in part by the third mold part 446, the substrate 396, the first groove 418 of the substrate 396, and the first side of the protrusion 448 of the third mold part 446. The second overmold cavity 486 is defined at least in part by the third mold part 446, the substrate 396, the second groove 420 of the substrate 396, and the second side of the protrusion 448 of the third mold part 446. In this way, the seals 480, 482 between the third mold part 446 and the substrate 396 prevent leakage between the first overmold cavity 484 and the second overmold cavity 486.

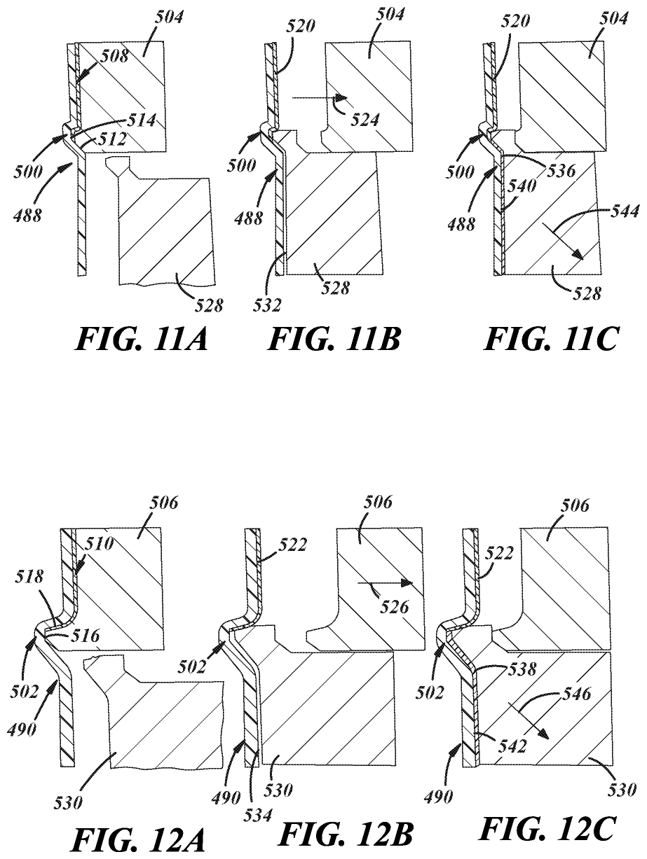

In at least some implementations, different mold parts may be used to form the first and second overmolded layers. As shown in FIGS. 11a and 12a, the substrate 488, 490, which may be formed by first and second mold parts, so that the substrate 488, 490 has a groove 500, 502, as previously described herein. A third mold part 504, 506 may be positioned to contact the substrate 488, 490 in the groove 500, 502 and to form at least part of the first overmold cavity 508, 510. As shown in FIG. 11a, the first third mold part 504 may contact the second sidewall 512 of the groove 500 so that the first overmold cavity 508 extends along the base 514 to the second sidewall 512. Alternatively, as shown in FIG. 12a, the third mold part 506 may contact the base 516 of the groove 502 so that the first overmold cavity 510 extends along the first sidewall 518 to the base 516.

As shown in FIGS. 11b and 12b, after forming the first overmolded layer 520, 522 in the first overmold cavity 508, 510, the third mold part 504, 506 may be removed from the substrate 488, 490 and first overmolded layer 520, 522 in a first mold removal direction 524, 526. A fourth mold part 528, 530 may be placed in contact with one or both of the substrate 488, 490 and the first overmolded layer 520, 522 within the groove 500, 502 to form at least part of the second overmold cavity 532, 534. When the first overmolded layer 520, 522 defines part of the second overmold cavity 532, 534, an outer surface 536, 538 of the overmolded layers 520, 522 may be in contact with each other and continuous from the first overmolded layer 520, 522 to the second overmolded layer 540, 542 without a gap between them. As shown in FIG. 11b, the fourth mold part 528 may be positioned over a portion of the first overmolded layer 520 that is in the base 514 of the groove 500, so that the second overmold cavity 534 is defined at least partially by the substrate 488, the second sidewall 512, the fourth mold part 528, and the first overmolded layer 520. Alternatively, as shown in FIG. 12b, the fourth mold part 530 may be positioned over a portion of the first overmolded layer 522 that is on the first sidewall 518 of the groove 502, so that the second overmold cavity 534 is defined at least partially by the substrate 490, the first sidewall 518, the base 516 of the groove 502, the fourth mold part 530, and the first overmolded layer 522.

As shown in FIGS. 11c and 12c, the third mold part 504, 506 may be moved into contact with the fourth mold part 528, 530 to provide a compression force and assist in forming the second overmolded layer 540, 542, if desired. After the second overmolded layer 540, 542 is formed in the second overmold cavity 510, 512, the fourth mold part 528, 530 may be removed from the overmolded layers 520, 522, 540, 541 at a second mold removal direction 544, 546. In at least some implementations, the second mold removal direction 544, 546 may be not parallel to the first mold removal direction 524, 526. In at least some implementations, the second mold removal direction 544, 546 may be between 10 and 90 degrees from the first mold removal direction 524, 526, and the second mold direction 544, 546 may be selected as a function of and less than an angle of the second sidewall 512, 513 of the groove 500, 502 in the substrate 488, 490, to ensure that the fourth mold part 528, 530 can freely be moved without damaging the second overmolded layer 540, 542.

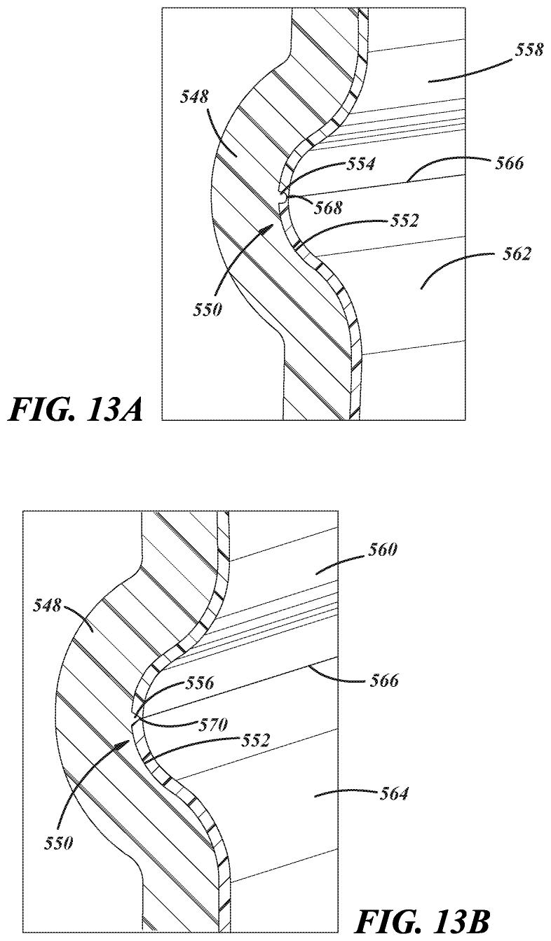

Referring now to FIGS. 13a and 13b, the substrate 548 may have a groove 550 that extends inwardly from the outer surface 552 and a rib 554, 556 may be provided in the groove 550, or otherwise on the outer surface 552 of the substrate 548 if a groove is not formed in the substrate 548. The rib 554, 556 may be positioned at least partly between the overmolded layers 558, 562, 560, 564, and may define part of the first overmold cavity and the second overmold cavity in which the overmolded layers 558, 562, 560, 564 are formed. In the examples shown, the rib 554, 556 extends from the outer surface 552 a distance less than the thickness of the overmolded layers 554, 556. Thus, the rib 554, 556 separates the overmolded layers 558, 562, 560, 564 at the junction 566 of the overmolded layers 558, 562, 560, 564 with the substrate 548 but allows contact of the overmolded layers 558, 562, 560, 564 over the rib 554, 556. This enables the overmolded layers 558, 562, 560, 564 to be joined and continuous without a gap between them, if desired. As shown in FIG. 13a, in at least some implementations, the peak or end 568 of the rib 554 may be round in shape. As shown in FIG. 13b, in at least some implementations, the rib 556 may have a triangular cross-section with a thin edge at the end or peak 570 of the rib 556. Still other shapes may be used.

Vehicle components such as front fascias, body panels, or other exterior or interior parts may include assemblies of two or more pieces to achieve multi-color or multi-textured appearances. While such assemblies can provide aesthetic flexibility, they increase the production cost and assembly time of each component due to additional parts, tooling, and assembly operations. Multi-piece assemblies may also introduce added manufacturing complexity, including alignment challenges, and the need for fastening or bonding processes. Further, interfaces between assembled pieces can create visible seams, potential squeaks or rattles, and durability concerns over time, such as loosening, wear, or environmental degradation at the joint regions. Therefore, a method 600 for forming a multi-appearance overmolded vehicle component is presented in FIG. 14.

The method 600 may include a step 602 of providing a mold cavity. A first mold part and a second mold part may be arranged to form at least part of the mold cavity.

In step 604, a first material is provided into the mold cavity to form a substrate having a predetermined shape and geometry. Once the mold cavity is filled, the first material may be allowed to fully or partially cure within the mold, or the substrate may be removed from the mold cavity. Depending on the material used, curing of the substrate may occur through cooling, a chemical reaction, or a combination thereof. For example, thermoplastic materials may cure as they cool below a solidification temperature, while thermoset or reactive materials may cure through a chemical crosslinking process that may be accelerated by heat, pressure, or time within the mold cavity. In implementations wherein the substrate remains in the mold cavity, the second mold part may then be moved at a first mold removal direction to expose the outer surface of the substrate.

Next, in step 606, a first overmold cavity is provided. In at least some implementations, the first overmold cavity may be defined at least in part by the substrate and a third mold part. In step 608, a second material is provided into the first overmold cavity to form a first overmolded layer. The second material, such as a first polyurethane reactive (PUR) material, may be injected into the first overmold cavity to form the first overmolded layer. During injection, the first PUR material flows into and fills the first overmold cavity. After the mold cavity is filled, the PUR material undergoes a curing process in which a chemical reaction causes the material to polymerize and solidify. The curing of the PUR substrate may occur at ambient or elevated temperatures and may be controlled by time, heat, or pressure within the mold to achieve the desired mechanical properties before subsequent processing or removal from the mold. As described herein, the first PUR material may have a first appearance, such as, but not limited to, a first color, a first texture, a first tint, a first transparency, or a first finish, and/or the first PUR material may have a first material composition. The method 600 may proceed to step 610.

In step 610, a second overmold cavity is provided. In at least some implementations, the first overmold cavity and the second overmold cavity may be defined simultaneously by the substrate and a third mold part. In at least some implementations, the second overmold cavity is defined at least partially by a mold part that is different from the mold part(s) that forms the first overmold cavity. In implementations with a fourth mold part, the second overmold cavity may be defined at least partially by the substrate, the fourth mold part, and optionally, the first overmolded layer.

In step 612, a third material to form a second overmolded layer is provided in the second overmold cavity. In at least some implementations, where the first and second overmold cavities are formed simultaneously, steps 608 and 612 may occur simultaneously, or in close succession, as desired. In at least some implementations, where the second overmold cavity is formed by a fourth mold part, the third material may be injected after the second material or after the second material has partially cured or set. The third material, such as a second polyurethane reactive (PUR) material, may be injected into the second overmold cavity to form the second overmolded layer. During injection, the second PUR material flows into and fills the second overmold cavity and conforms to the second overmold cavity. After the mold cavity is filled, the PUR material undergoes a curing process in which a chemical reaction causes the material to polymerize and solidify. The curing of the PUR substrate may occur at ambient or elevated temperatures and may be controlled by time, heat, or pressure within the mold to achieve the desired mechanical properties before subsequent processing or removal from the mold. As described herein, the second PUR material may have a second appearance that may be different than the first appearance, such as, but not limited to, a second color, a second texture, a second tint, a second transparency, or a second finish, and/or the second PUR material may have a second material composition that may be different from the first PUR material.

Therefore, the method 600 describes manufacturing a single vehicle component having two or more overmolded layers with two, distinct appearances and/or material compositions. The component may be a front fascia, rear fascia, other vehicle body panels, exterior components, or other vehicle parts. The multiple appearances may be achieved on a single substrate and provide additional design options for vehicle components, including increased options for overmolding flowable materials like PUR onto substrates.

What is claimed is:

1. A method for forming an overmolded component, comprising:
providing a substrate within a mold assembly having multiple mold parts;
providing a first overmold cavity that is defined at least in part by the substrate and one or more of the mold parts;
providing a second overmold cavity that is defined at least in part by the substrate and one or more of the mold parts; and
providing a material in the first overmold cavity to form a first overmolded layer on the substrate and into the second overmold cavity to form a second overmolded layer on the substrate, wherein the first overmolded layer is formed separately from the second overmolded layer.

2. The method of claim 1, wherein one of the mold parts engages the substrate between the first overmold cavity and the second overmold cavity to prevent material in the first overmold cavity from flowing into the second overmold cavity and vice versa.

3. The method of claim 2, wherein said one of the mold parts defines part of one or both of the first overmold cavity and the second overmold cavity.

4. The method of claim 1, wherein the material provided in the first overmold cavity is a polyurethane with a first appearance or first material composition and the material provided in the second overmold cavity is a polyurethane with a second appearance that is different than the first appearance or a second material composition that is different than the first material composition.

5. The method of claim 4, wherein the first appearance is a first color, a first texture, a first gloss or reflectivity, a first pattern, a first transparency, or a first surface finish and the second appearance is a second color, a second texture, a second gloss or reflectivity, a second transparency, or a second finish.

6. The method of claim 1, wherein the substrate is molded in the mold system and remains in the mold system while the first overmolded layer and the second overmolded layer are formed on the substrate.

7. The method of claim 1, wherein the substrate has an outer surface that defines part of the first overmold cavity and part of the second overmold cavity, the substrate includes a separation feature in the outer surface and both of the first overmold cavity and the second overmold cavity are defined in part by part of the separation feature.

8. The method of claim 7, wherein the separation feature is a groove that extends inwardly into the outer surface of the substrate, and a step is formed within the groove, and the step defines at least part of the first overmold cavity or the second overmold cavity.

9. The method of claim 2, wherein said one of the mold parts engages the substrate within a groove of the substrate.

10. The method of claim 2, wherein the substrate has a first ridge, and said one of the mold parts has a protrusion in contact with the ridge to define at least part of one or both of the first overmold cavity and the second overmold cavity.

11. The method of claim 10 wherein the ridge defines part of one or both of the first overmold cavity and the second overmold cavity.

12. A method for forming an overmolded component, comprising:
forming a substrate within a mold assembly having multiple mold parts;
providing a first overmold cavity that is defined at least in part by the substrate and one or more of the mold parts;
providing a second overmold cavity that is defined at least in part by the substrate and one or more of the mold parts, wherein the second overmold cavity is spaced from the first overmold cavity;
providing a first overmold material in the first overmold cavity to form a first overmolded layer on the substrate; and
providing a second overmold material into the second overmold cavity to form a second overmolded layer on the substrate, wherein the first overmolded layer is different from the second overmolded layer in appearance, composition or both appearance and composition.

13. The method of claim 12 wherein the substrate is formed in a substrate cavity defined between a first mold part and a second mold part, and part of one or both the first overmold cavity and the second overmold cavity is defined by a third mold part that engages the substrate at an edge of the one or both of the first overmold cavity and the second overmold cavity.

14. The method of claim 13 wherein the first overmold cavity is formed in part by the third mold part and the second overmold cavity is formed in part by a fourth mold part, the third mold part engages the substrate at an edge of the first overmold cavity and the fourth mold part engages the substrate or the first overmolded layer at an edge of the second overmold cavity.

15. The method of claim 14 wherein the first overmolded layer is formed on the substrate first, the third mold part is withdrawn from the substrate, and then the fourth mold part is advanced onto the substrate and the second overmolded layer is formed on the substrate.

16. The method of claim 15 wherein the fourth mold part engages the first overmolded layer and the second overmold cavity is defined in part by the first overmolded layer.

17. The method of claim 11 wherein the first overmolded layer is different from the second overmolded layer in color, texture, gloss or reflectivity, pattern, transparency, or surface finish.

18. A vehicle component comprising:
a substrate with a separation feature that extends outwardly from or inwardly into an outer surface of the substrate;
a first overmolded layer formed on the outer surface of the substrate that contacts part of the separation feature and has a first appearance; and
a second overmolded layer formed on the outer surface of the substrate that contacts part of the separation feature and has a second appearance that is different from the first appearance.

19. The vehicle component of claim 18, wherein the first overmolded layer is formed of polyurethane with a first appearance and the second overmolded layer is formed of polyurethane with a second appearance that is different than the first appearance.

20. The vehicle component of claim 19, wherein the first appearance is a first color, a first texture, a first gloss or reflectivity, a first transparency, or a first finish and the second appearance is a second color, a second texture, a second gloss or reflectivity, a second transparency, or a second finish.

21. The vehicle component of claim 18, wherein the first overmolded layer and second overmolded layer are separated by a gap and are not in contact with each other.

22. The vehicle component of claim 18, wherein the first overmolded layer and the second overmolded layer are in contact with each other within a groove of the substrate that defines the separation feature, or on opposite sides of a ridge of the substrate that defines the separation feature.
